(19) United States
(12) Patent Application Publication
(10) Pub. No.: US 2008/0027630 A1
(43) Pub. Date: Jan. 31, 2008

(54) Positioning system with switching function and switching function performing method thereof

(76) Inventor: Chung-Hsien Chuang, Sanchong City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/727,321

(22) Filed: Mar. 26, 2007

(30) Foreign Application Priority Data
Jul. 26, 2006 (TW) 095127392

(51) Int. Cl. G01C 21/00

(52) U.S. Cl. 701/207

(57) ABSTRACT

A positioning system with a switching function includes a positioning information receiving module, a wireless signal receiving module, a transmission interface and a switching module. The positioning information receiving module is for receiving positioning information. A wireless signal receiving module is for receiving a wireless signal. The transmission interface is connected to a central processor of a positioning apparatus. The switching module is connected to the transmission interface and is for receiving a control signal in order to selectively switch a first state or a second state. When the switching module is at the first state, the transmission interface receives the positioning information transmitted by the positioning information receiving module through the switching module. When the switching module is at the second state, the transmission interface receives the wireless signal transmitted by the wireless signal receiving module through the switching module.

### FIELD OF THE INVENTION

The present invention relates to a positioning system with a switching function and a switching function performing method thereof, and more particularly to a positioning system that allows a positioning information receiving module and a wireless signal receiving module to share a set of universal asynchronous receiver transmitter (UART) by using a switch circuit.

### BACKGROUND OF THE INVENTION

In recent years, global positioning system (GPS) becomes increasingly popular, and more navigation software attempt enhancing the reliability of navigations and planned routes. For instance, traffic message channel (TMC) is a radio broadcast system which can provide a real-time traffic information to the drivers, but it requires a specific hardware device to receive information broadcasted from a radio station. In conventional positioning apparatus, it provides an additional set of universal asynchronous receiver transmitter (UART) for the traffic message channel (TMC) to transmit data. Referring to FIG. 1 for a block diagram of transmitting data by a positioning apparatus in accordance with a prior art, a central processor 11 is coupled to a first universal asynchronous receiver transmitter (UART) 12 and a second universal asynchronous receiver transmitter (UART) 13, wherein a global positioning system module 14 transmits positioning information 141 though the first universal asynchronous receiver transmitter (UART) 12, and a traffic message channel (TMC) module 15 transmits traffic information 151 through a second universal asynchronous receiver transmitter (UART) 13. However, the number of universal asynchronous receiver transmitters (UART) of the positioning apparatus is limited (generally to three sets), the positioning apparatus will run out of UART if there is another device requiring the use of a universal asynchronous receiver transmitter (UART).

To overcome the problem of having not enough universal asynchronous receiver transmitters (UART), a solution is provided by combining a handheld computer device of a terminal device as disclosed in European Patent Publication No. EP1347428. Referring to FIG. 2 for a block diagram of integrating a handheld computer device of a terminal device in accordance with a prior art, the handheld computer device 20 comprises a user interface 22, a central processor 11, at least one memory 21 and at least one hardware interface 24. The central processor 11 is coupled to a terminal device 25 through a single interface 251. The terminal device 25 has at least two hardware interfaces 24 and an operation unit 252 for controlling the hardware interfaces 24. One of the hardware interfaces 24 is used for receiving a traffic information stream 27 transmitted from the traffic message channel (TMC) module 15, and another hardware interface 24 is for receiving a positioning information stream 28 transmitted from the global positioning system module 14. The operation unit 252 combines the traffic information stream 27 and the positioning information stream 28 into a single serial information stream 26. The terminal device 25 transmits the single serial information stream 26 to the handheld computer device 20 through the single interface 251 and the hardware interface 24. The central processor 11 performs the decoding program 231 loaded in a memory area 23 to decode the single serial information stream 26. The single serial information stream 26 is decoded into the original traffic information stream 27 and positioning information stream 28, and processed by an application program of the handheld computer device 20.

For a traffic message channel (TMC) module, it needs to update data from station once in a certain time interval, and the navigation software also does not require frequent update of the traffic information provided by the traffic message channel (TMC) module. Therefore, the conventional method may improve the applicability of the hardware interface, but it causes a waste of power as to the power management of the handheld computer device. The inventor of the present invention based on years of experience in the related field to conduct extensive researches and experiments, and finally developed a positioning system with switching function and switching function performing method thereof in accordance with the present invention to overcome the foregoing shortcomings of the prior art.

### SUMMARY OF THE INVENTION

Therefore, it is a primary objective of the present invention to provide a positioning system with a switching function and a switching function performing method thereof, and more particularly a positioning system that allows a positioning information receiving module and a wireless signal receiving module to share a set of universal asynchronous receiver transmitter (UART) by using a switch circuit.

To achieve the foregoing objective, a positioning system with a switching function of the invention comprises a positioning information receiving module, a wireless signal receiving module, a transmission interface and a switching module. The positioning information receiving module is for receiving a positioning information, and the wireless signal receiving module is for receiving a wireless signal, and the transmission interface is coupled to a central processor of the positioning apparatus, and the switching module is coupled to transmission interface for receiving a control signal to selectively switch to a first state or a second state. If the switching module is situated at the first state, the transmission interface will receive positioning information from the positioning information receiving module through the switching module. If the switching module is situated at the second state, the transmission interface will receive a wireless signal from the wireless signal receiving module through the switching module.

Since the positioning system with switching function and switching function performing method thereof in accordance with the present invention integrates a positioning information receiving module and a wireless signal receiving module. With the hardware switch circuit, the purpose of occupying only one set of universal asynchronous receiver transmitter (UART) can be achieved, and a more efficient power management for the wireless signal receiving module can be accomplished.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

FIG. 1 is a block diagram of transmitting data by a positioning apparatus in accordance with a prior art;

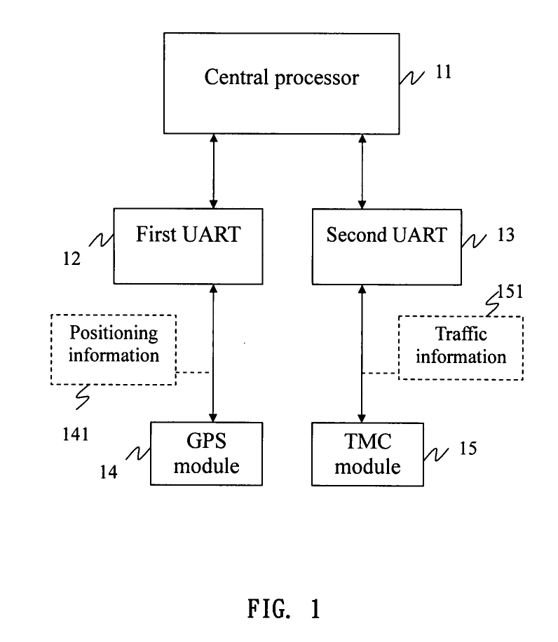

FIG. 2 is a block diagram of integrating a handheld computer device of a terminal device in accordance with a prior art;

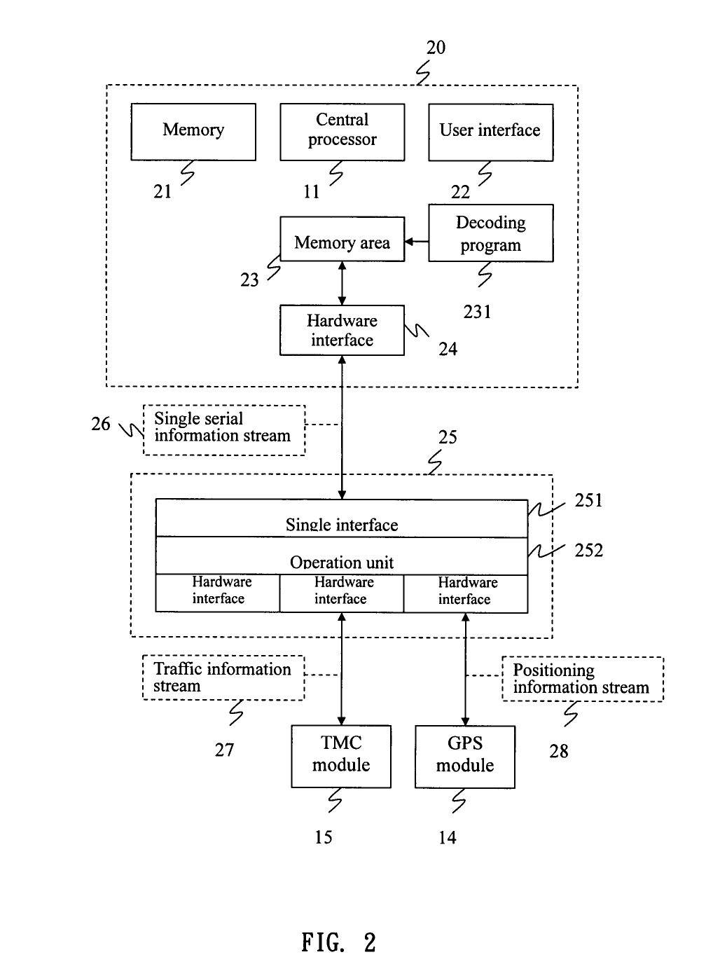

FIG. 3 is a block diagram of a positioning system with a switching function in accordance with the present invention;

FIG. 4 is a block diagram of a positioning system with a switching function in accordance with a preferred embodiment of the present invention;

FIG. 5 is a flow chart of a switching function performing method of a positioning system in accordance with the present invention; and

FIG. 6 is a flow chart of a switching function performing method of a positioning system in accordance with a preferred embodiment of the present invention.

### DETAILED DESCRIPTION OF THE PREFERRED EMBODIMENTS

In the following related figures, same reference numerals are used for the same elements of a positioning system with a switching function and a switching function performing method thereof in accordance with a preferred embodiment of the present invention.

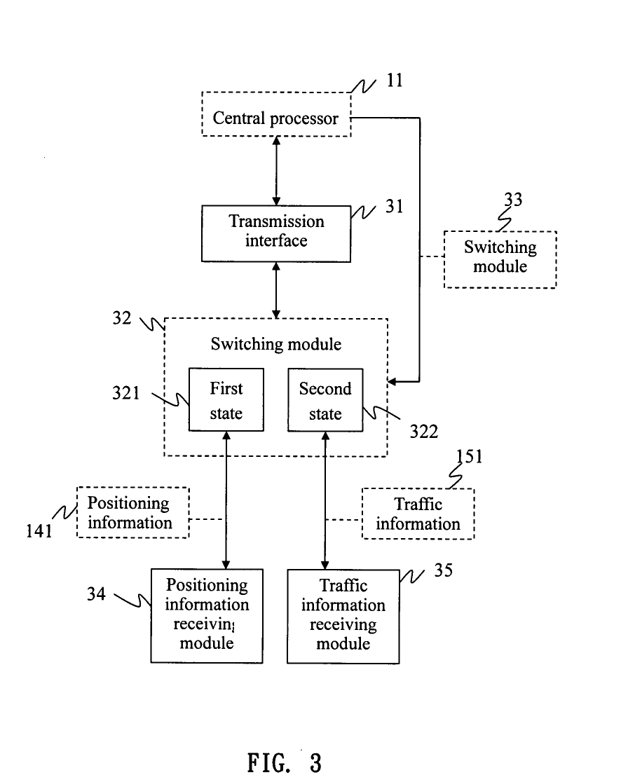

Referring to FIG. 3 for a block diagram of a positioning system with a switching function in accordance with the present invention, the positioning system comprises a positioning information receiving module 34, a wireless signal receiving module 35, a transmission interface 31 and a switching module 32. The positioning information receiving module 34 is for receiving a positioning information 141, and the wireless signal receiving module 35 is for receiving a wireless signal 151, and the transmission interface 31 is coupled to a central processor 11 of the positioning apparatus, and the switching module 32 is coupled to the transmission interface 31 for receiving a control signal 33 to selectively switch to a first state 321 or a second state 322. If the switching module 32 is situated at the first state 321, the transmission interface 31 will receive positioning information 141 from the positioning information receiving module 34 through the switching module 32. If the switching module 32 is situated at the second state 322, the transmission interface 31 will receive a wireless signal 151 from the wireless signal receiving module 35 through the switching module 32.

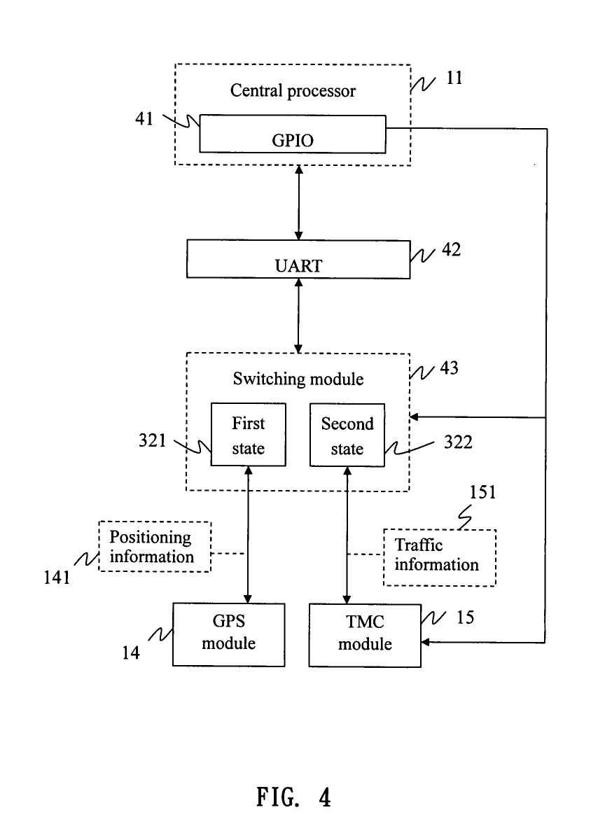

The positioning information receiving module is a global positioning system module (GPS), and the wireless signal receiving module is preferably a traffic information receiving module, and the traffic information receiving module preferably receives the traffic information through a traffic message channel (TMC), a radio data system (RDS) or a digital audio broadcasting (DAB). The transmission interface is preferably a universal asynchronous receiver transmitter (UART), and the positioning system further comprises a control module that outputs a control signal to control the power on/off of the wireless signal receiving module. The control module is preferably a general purpose input/output (GPIO) of a central processor of the positioning system. Referring to FIG. 4 for a block diagram of a positioning system with a switching function in accordance with a preferred embodiment of the present invention, the positioning system comprises a central processor 11, a general purpose input/output (GPIO) 41, a universal asynchronous receiver transmitter (UART) 42, a switch circuit 43, a global positioning system module 14 and a traffic message channel (TMC) module 15. The global positioning system module 14 is for receiving positioning information 141 from a satellite, and the traffic message channel (TMC) module 15 is for receiving traffic information 151 broadcasted by a radio station, and the universal asynchronous receiver transmitter (UART) 42 is coupled to a central processor 11 of the positioning apparatus. The switch circuit 43 is coupled to the universal asynchronous receiver transmitter (UART) 42 and has a first state 321 and a second state 322, such that if the switch circuit 43 is situated at the first state 321, the universal asynchronous receiver transmitter (UART) 42 will receive positioning information 141 from the global positioning system module 14, and if the switch circuit 43 is situated at the second state 322, the universal asynchronous receiver transmitter (UART) 42 will receive traffic information 151 from the traffic message channel (TMC) module 15. The general purpose input/output (GPIO) 41 is built in the central processor 11 for controlling the state of the switch circuit 43 and the power on or off of the traffic message channel (TMC) module 15.

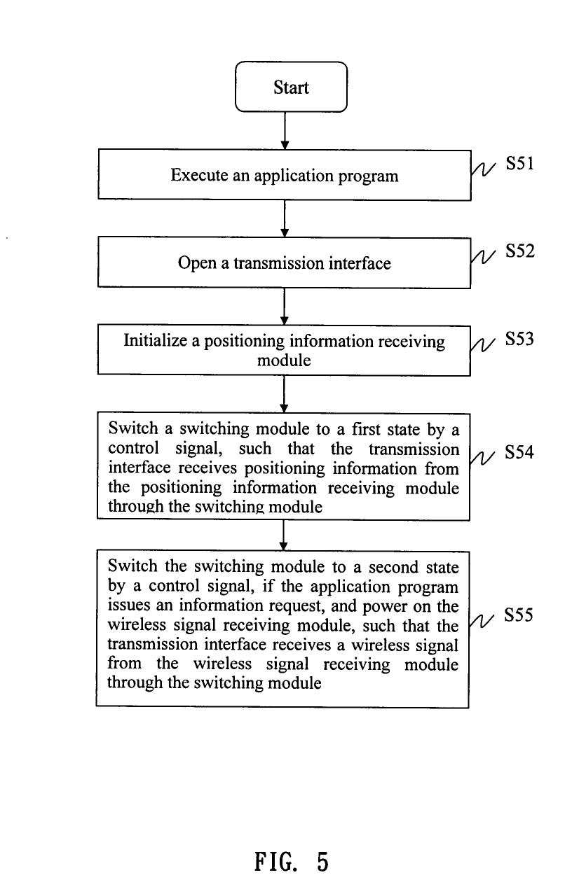

Referring to FIG. 5 for a flow chart of a switching function performing method for a positioning system in accordance with the present invention, the method comprises the steps of:

Step S51: executing an application program;

Step S52: opening a transmission interface;

Step S53: initializing a positioning information receiving module;

Step S54: switching a switching module to a first state by a control signal, such that the transmission interface receives positioning information from the positioning information receiving module through the switching module; and

Step S55: switching the switching module to a second state by the control signal, if the application program issues an information request, and powering on the wireless signal receiving module, such that the transmission interface receives a wireless signal from the wireless signal receiving module through the switching module.

In the description above, the application program is preferably a navigation program, and the positioning information receiving module is preferably a global positioning system module, and the wireless signal receiving module is preferably a traffic information receiving module, and the traffic information receiving module preferably receives the traffic information through a traffic message channel (TMC), a radio data system (RDS) or a digital audio broadcasting (DAB), and the aforementioned transmission interface is preferably a universal asynchronous receiver transmitter (UART), and the positioning system further comprises a control module for outputting a control signal, and controlling the power on or off of the wireless signal receiving module, and the control module is preferably a general purpose input/output (GPIO) of the positioning system central processor.

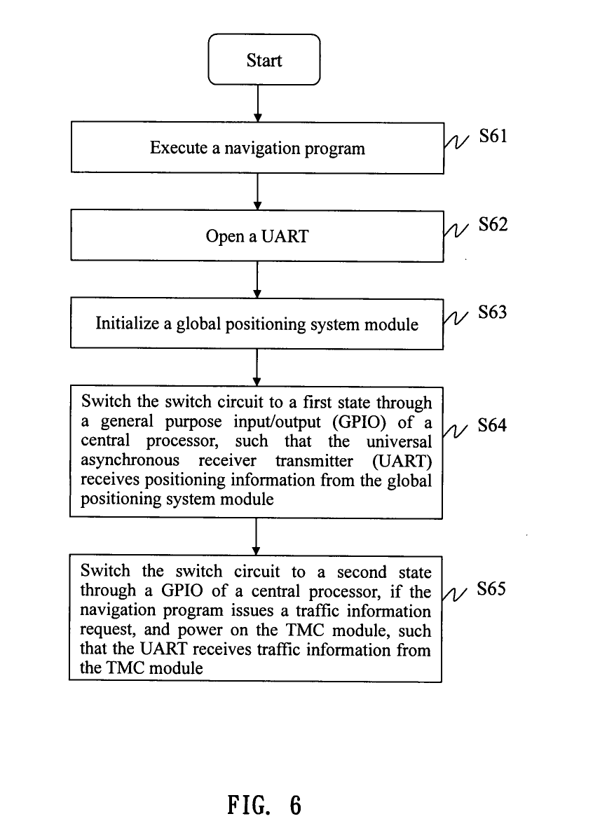

Referring to FIG. 6 for a flow chart of a switching function performing method for a positioning system in accordance with a preferred embodiment of the present invention, the method comprises the steps of:

Step S61: executing a navigation program;

Step S62: opening a universal asynchronous receiver transmitter (UART);

Step S63: initializing a global positioning system module;

Step S64: switching the switch circuit to a first state through a general purpose input/output (GPIO) of a central processor, such that the universal asynchronous receiver transmitter (UART) receives positioning information from the global positioning system module; and

Step S65: switching the switch circuit to a second state through a general purpose input/output (GPIO) of a central processor, if the navigation program issues a traffic information request, and powering on the traffic message channel (TMC) module, such that the universal asynchronous receiver transmitter (UART) receives traffic information from the traffic message channel (TMC) module.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A positioning system with a switching function, comprising:
a positioning information receiving module, for receiving a positioning information;
a wireless signal receiving module, for receiving a wireless signal;
a transmission interface, coupled to a central processor of said positioning apparatus; and
a switching module, coupled to said transmission interface, for receiving a control signal to selectively switch to a first state or a second state, such that if said switching module is situated at said first state, then said transmission interface will receive said positioning information from said positioning information receiving module through said switching module, and if said switching module is situated at said second state, said transmission interface will receive said wireless signal from said wireless signal receiving module through said switching module.

2. The positioning system with a switching function of claim 1, wherein said wireless signal receiving module is a traffic information receiving module for receiving traffic information broadcasted by a radio station.

3. The positioning system with a switching function of claim 1, wherein said positioning information receiving module is a global positioning system (GPS) module.

4. The positioning system with a switching function of claim,2, wherein said traffic information receiving module receives said traffic information through a traffic message channel (TMC).

5. The positioning system with a switching function of claim 2, wherein said traffic information receiving module receives said traffic information through a radio data system (RDS).

6. The positioning system with a switching function of claim 2, wherein said traffic information receiving module receives said traffic information through a digital audio broadcasting (DAB).

7. The positioning system with a switching function of claim 1, wherein said transmission interface is a universal asynchronous receiver transmitter (UART).

8. The positioning system with a switching function of claim 1, further comprising a control module for issuing said control signal, and controlling the power on or off of said wireless signal receiving module.

9. The positioning system with a switching function of claim 8, wherein said control module is a general purpose input/output (GPIO) of a central processor of said positioning system.

10. A switching function performing method for a positioning system, comprising:
executing an application program;
opening a transmission interface;
initializing a positioning information receiving module;
switching a switching module to a first state through a control signal, such that said transmission interface receives positioning information from said positioning information receiving module through said switching module; and
switching said switching module to a second state through said control signal if said application program issues an information request, and powering on said wireless signal receiving module, such that said transmission interface receives a wireless signal from said wireless signal receiving module through said switching module.

11. The switching function performing method for a positioning system of claim 10, wherein said wireless signal receiving module is a traffic information receiving module for receiving traffic information broadcasted by a radio station.

12. The switching function performing method for a positioning system of claim 10, wherein said application program is a navigation program.

13. The switching function performing method for a positioning system of claim 10, wherein said positioning information receiving module is a global positioning system module.

14. The switching function performing method for a positioning system of claim 11, wherein said traffic information receiving module receives said traffic information through a traffic message channel (TMC).

15. The switching function performing method for a positioning system of claim 11, wherein traffic information receiving module receives said traffic information through a radio data system (RDS).

16. The switching function performing method for a positioning system of claim 11, wherein traffic information receiving module receives said traffic information through a digital audio broadcasting (DAB).

17. The switching function performing method for a positioning system of claim 10, wherein said transmission interface is a universal asynchronous receiver transmitter (UART).

18. The switching function performing method for a positioning system of claim 10, further comprising a step of providing a control module for issuing said control signal, and controlling the power on or off of said wireless signal receiving module.

19. The switching function performing method for a positioning system of claim 18, wherein said control module is a general purpose input/output (GPIO) of said positioning apparatus central processor.
